(19) United States
(12) Patent Application Publication
(10) Pub. No.: US 2016/0210580 A1
(43) Pub. Date: Jul. 21, 2016

(54) METHOD OF DETERMINING AVAILABILITY AND RELIABILITY OF FACILITY EQUIPMENT

(71) Applicant: CONOCOPHILLIPS COMPANY, Houston, TX (US)

(72) Inventors: Carl J. RYDLAND, Houston, TX (US); Gary A. RICHARDSON, Darwin (AU)

(21) Appl. No.: 15/003,414

(22) Filed: Jan. 21, 2016

Related U.S. Application Data
(60) Provisional application No. 62/106,020, filed on Jan. 21, 2015.

(51) Int. Cl. G06Q 10/06; G06F 3/0488

(52) U.S. Cl. CPC G06Q 10/06393; G06F 3/0488

(57) ABSTRACT

A method of determining availability and reliability of facility equipment. The method includes monitoring an operational status of a piece of equipment of a facility. The method also includes outputting a visual display illustrating the operational status of the equipment, wherein the operational status is categorized into a plurality of categories, at least one of the plurality of categories requiring an operator to classify an interruption of function of the equipment as one of a planned outage, a forced outage, and a standby mode. The method further includes calculating a reliability percentage of the equipment based on a total amount of time classified as the forced outage. The method yet further includes calculating an availability percentage of the equipment based on a total amount of time classified as the forced outage and the planned outage.

### CROSS-REFERENCE TO RELATED APPLICATIONS

This application is a non-provisional application which claims benefit under 35 USC §119(e) to U.S. Provisional Application Ser. No. 62/106,020 filed Jan. 21, 2015, entitled “METHOD OF DETERMINING AVAILABILITY AND RELIABILITY OF FACILITY EQUIPMENT,” which is incorporated herein in its entirety.

### STATEMENT REGARDING FEDERALLY SPONSORED RESEARCH

None.

### FIELD OF THE INVENTION

This invention relates to a method of determining availability and reliability of facility equipment.

### BACKGROUND OF THE INVENTION

Monitoring of equipment in various facilities is desirable for a variety of reasons. Data associated with efficiency of individual pieces of equipment operating in the facility is useful. The data may be used to calculate industry standardized efficiency values, such as reliability and availability of the equipment being used. To calculate such values, it is necessary to know why certain equipment was not functioning for certain periods of time. Commonly, an operator such as a reliability engineer spends time going over logs of a previous time period to identify all hours that equipment was not functioning properly. To summarize the data for efficiency calculation purposes, the operator must then cross-check all available logs for the equipment in question to assign a reason why the equipment was not functioning. This is clearly a time-consuming effort and often results in conjecture by the operator. Exacerbating the problem is the fact that data may be missing from the logs and people are left to rely on memory over a period of weeks to recall the reason for the non-functioning status. Consequently, the output of the work is prone to less than optimal accuracy.

### SUMMARY OF THE INVENTION

In one embodiment of the invention, a method of determining availability and reliability of facility equipment. The method includes monitoring an operational status of a piece of equipment of a facility. The method also includes outputting a visual display illustrating the operational status of the equipment, wherein the operational status is categorized into a plurality of categories, at least one of the plurality of categories requiring an operator to classify an interruption of function of the equipment as one of a planned outage, a forced outage, and a standby mode. The method further includes calculating a reliability percentage of the equipment based on a total amount of time classified as the forced outage. The method yet further includes calculating an availability percentage of the equipment based on a total amount of time classified as the forced outage and the planned outage.

In another embodiment of the invention, a method of determining availability and reliability of facility equipment. The method includes monitoring an operational status of a piece of equipment of a facility. The method also includes outputting a visual display illustrating the operational status of the equipment, wherein the operational status is categorized into a first category, a second category and a third category, the first category comprising a functioning status of the equipment, the second category comprising a currently functioning and recently interrupted functioning status of the equipment, and the third category comprising a non-functioning status of the equipment. The method further includes prompting an operator to classify an interruption of function of the equipment as one of a planned outage, a forced outage, and a standby mode, in the event of the equipment being categorized as the second category or the third category. The method yet further includes classifying the interruption of function of the equipment by interacting with the visual display.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 schematically illustrates a plurality of pieces of equipment of a facility and a visual output of an operational status of the equipment;

FIG. 2 schematically illustrates the visual output facilitating a method of determining reliability and availability of the equipment; and

FIG. 3 is a flow diagram illustrating the method according to an aspect of the invention.

### DETAILED DESCRIPTION OF THE INVENTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variation can be made without departing from the scope or spirit of the invention. For instance, features illustrated or described as part of one embodiment can be used on another embodiment to yield a still further embodiment. Thus, it is intended that the invention cover such modifications and variations that come within the scope of the appended claims and their equivalents.

As will be understood from the description below, disclosed is a system and method for monitoring equipment in a facility for accurate and reliable recordation of the data obtained from the monitoring. The data obtained is also useful for calculating reliability and availability according to industry standardized formulas.

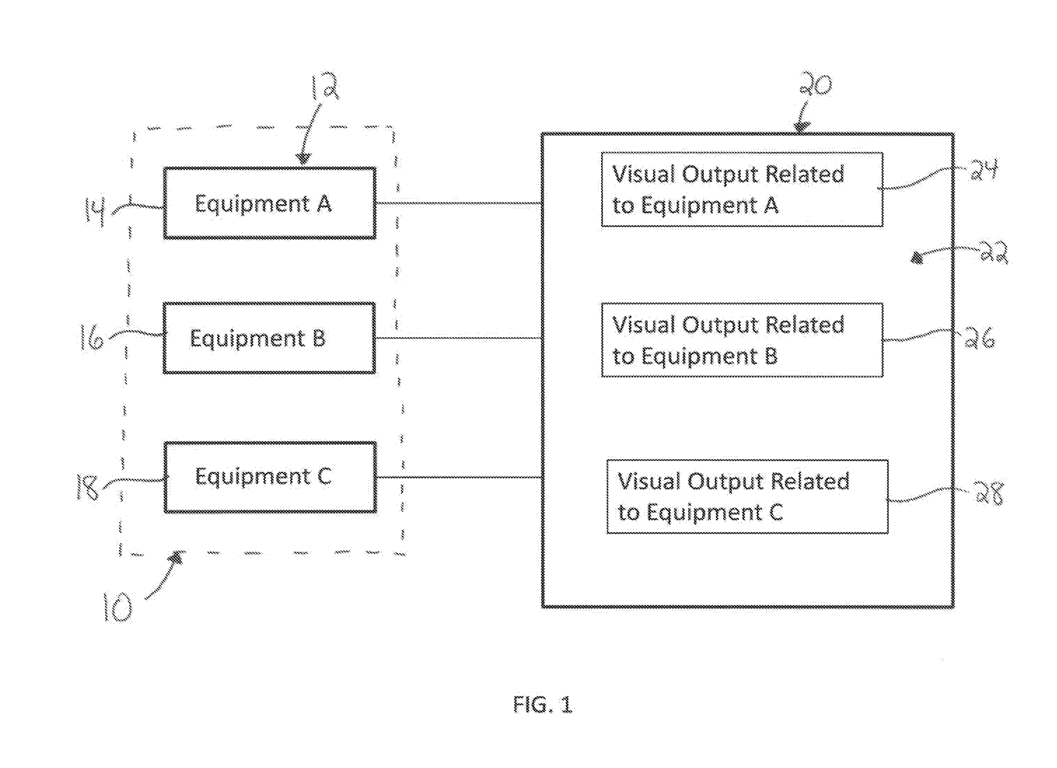

Referring to FIG. 1, a facility 10 is represented in a simplified manner with a plurality of pieces of equipment 12. A large number of types of facilities that may benefit from the embodiments of the invention described herein are contemplated. For example, a well facility associated with the exploration, extraction and/or production of hydrocarbons, such as oil and gas, is contemplated. Additionally, the facility may be a power plant. These are merely illustrative embodiments of the facility 10 and it is to be understood that any facility that has powered, running equipment will benefit from the embodiments described herein. A system 20 monitors the equipment 12 of the facility 10. The equipment 12 monitored will vary depending upon the particular facility in which it is employed. As used herein, “equipment” refers to systems, sub-systems, assemblies, sub-assemblies, or individual components. For example, the equipment may refer to rotating equipment. More specifically, in some embodiments the equipment refers to a compressor, a pump, a generator, a turbine or the like.

In the illustrated example, three pieces of equipment 12 are shown, but it is to be appreciated that more or less equipment may be monitored by the system 20. A first piece of equipment is referenced with numeral 14, a second piece of equipment with numeral 16 and a third piece of equipment with numeral 18. Each piece of equipment is in operative communication with the system 20 in a wired and/or wireless manner. The system 20 refers to one or more processing devices that are configured to receive and transmit data and perform a variety of tasks.

The system 20 includes a visual display 22 that displays information related to each of the pieces of equipment 14, 16, 18. A visual output associated with each of the respective pieces of equipment 14, 16, 18 is provided. In particular, a first visual output 24 is associated with the first piece of equipment 14, a second visual output 26 is associated with the second piece of equipment 16, and a third visual output 28 is associated with the third piece of equipment 18. The visual outputs 24, 26, 28 vary depending upon an operational status of the pieces of equipment. More precisely, the system 20 categorizes the operational status of the equipment individually into a plurality of categories. In one embodiment, three categories are included. A first category relates to a functioning status of the piece of equipment. A piece of equipment is categorized in this category when the piece of equipment is functioning properly and has not shown signs of non-functional operation. A second category relates to a piece of equipment that is functioning, but that been observed to be recently in a non-functioning state. A third category relates to a piece of equipment that is currently in a non-functioning state.

The visual output associated with each of the respective categories may be any visual output that allows a human operator to easily and confidently identify which of the categories the associated piece of equipment is currently in. In other words, any visual prompt in the form of text and/or graphics may be used to differentiate the categories. In one embodiment, the visual outputs are color-coded to signify the category to the operator, such that each category of operational status is identified by a unique color. For example, the first category may be identified with a green light, the second category may be identified with a yellow light, and the third category may be identified with a red light. This color combination has been found to be a reliable combination based on a human's intuition associated with these colors.

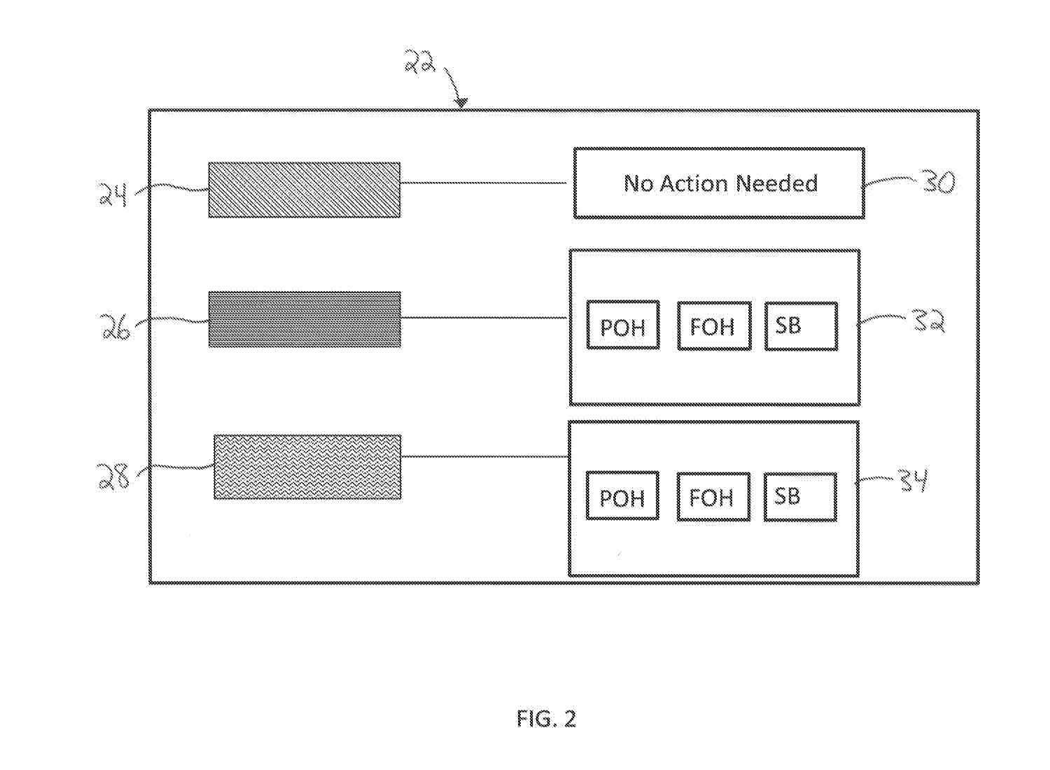

Referring to FIG. 2, the distinct visual outputs 24, 26, 28 are distinguished in the illustration as distinct patterns to generally represent any differentiating visual outputs, such as the color-coded display described in detail above. The type of visual output displayed to the operator indicates the operational status of each piece of equipment being monitored, as described above. This information dictates whether action is required by the operator. In the illustrated embodiment, by way of example, the first visual output 24 is displaying an output (e.g., green light) associated with the first category of operational status. This informs the operator that no action is required based on the fully functioning status of the first piece of equipment 14. The second visual output 26 is displaying an output (e.g., yellow light) associated with the second category of operational status. This informs the operator that, although the second piece of equipment 16 is currently running, the equipment recently experienced downtime and the reason for that downtime has not yet been input into the system 20. The third visual output 28 is displaying an output (e.g., red light) associated with the third category of operational status. This informs the operator that the third piece of equipment 18 is currently non-functioning and the reason for the downtime has not yet been input into the system 20.

Continuing with the above-described example, the visual output associated with the first category of operational status requires no action by the operator, as noted above. An additional display in the form of a separate window or the like may be displayed to confirm that no action is needed. The second and third categories of operational status require action by the operator. In the current example, the second visual output 26 and the third visual output 28 display outputs (e.g., yellow light and red light) associated with the second and third categories, respectively. Upon viewing these displays, the operator is aware that action is required and the system 20 thereby prompts such action. The operator determines the reason for the non-functioning status of the respective piece of equipment and takes action to input a classification of the reason into the system 20.

The operator classifies the reason for the non-functioning status of the equipment into one of three classifications. The first classification is represented by “POH” in the illustrated embodiment. This classification represents planned outage hours and represents the amount of time that a piece of equipment was non-functioning due to a planned outage activity, such as planned maintenance, for example. The second classification is represented by “FOH” in the illustrated embodiment. This classification represents forced outage hours and represents the amount of time that a piece of equipment was non-functioning due to an unplanned activity. The third classification is represented by “SB” in the illustrated embodiment. This classification represents a standby mode where the equipment is not needed at the moment.

The operator inputs the determined classification by interacting with the system 20. In one embodiment, this includes interacting directly with the visual display 22. This may be done by physically touching a screen if the visual display 22 is a touch screen. Alternatively, a standard computer mouse may be employed to scroll and “click” to achieve the inputs. Certain pop-up windows 30, 32, 34 may be provided when the operator interacts with the respective visual outputs 24, 26, 28. The pop-up windows may provide more detailed information about the associated piece of equipment. Such information may relate to a detailed catalogue of information for all of the periods of downtime over a predetermined period of time. For example, the information may contain a list of the recent downtime periods and the determined classifications of the reasons for the downtime periods.

The significance of the collection of this data, particularly the breakdown into the three classifications described above, relates to the ability to accurately calculate the reliability and availability of the monitored equipment 12. Industry standardized formulas contain variables that represent the planned outage time and the forced outage time. In particular, the reliability percentage of a piece of equipment is calculated as follows:

$$R ( \% ) = \frac{PH - FOH}{PH} * 100$$

The availability percentage of a piece of equipment is calculated as follows:

$$A ( \% ) = \frac{PH - ( FOH + POH )}{PH} * 100$$

In the above-described formulas, the following are definitions of the variables: R (reliability): the probability that equipment will not be in a forced outage condition at a point in time;

A (availability): the probability that equipment will be usable at a point in time;
PH (period hours): the number of hours in a time period in question;
FOH (forced outage hours): the number of hours equipment was not running due to an unplanned event; and
POH (planned outage hours): the number of hours equipment was not running due to a planned event.

By incorporating the above-described method into the data collection effort, the planned outage time and forced outage time are reliably obtained. This is due to the elimination of an operator attempting to account for the downtime of equipment at a much later date. The method described herein efficiently prompts the operator to determine the reason for downtime and inputting this reason into the system 20. This data is sent to a database for storage therein. The calculations of the reliability and availability may be performed prior to inputting the data into the database or subsequently.

As described above, the recording of data employed to calculate the reliability and the availability of equipment is done efficiently and accurately. This enables a comparison of the calculated reliability and availability to calculations made at other facilities. This allows for similar equipment to be compared across the world, regardless of the type of facility the equipment is employed in. The comparison is more reliable based on the reduction of the human element due to the standardized recording method described herein.

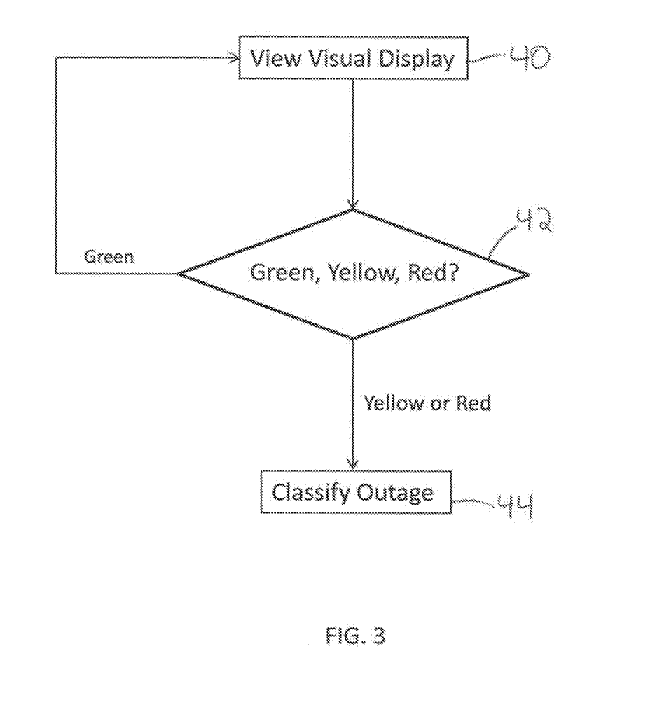

Referring now to FIG. 3, the method described herein is summarized for illustrative purposes in a flow chart that represents the main functions of an operator carrying out the method. In particular, the operator views 40 the visual display 22 and identifies 42 which category of operational status the display outputs 24, 26, 28 correspond to. In the illustrated embodiment, the color-coded identification scheme is employed, but as described above any differentiating visual prompts may be suitable. Consistent with the color-coded example, the operator determines whether the display outputs 24, 26, 28 are green, yellow or red, respectively. As described above, if the display is associated with the first category (e.g., green light), no action is required and the operator simply refers back to viewing the visual display after a period of time. If the display is associated with the second or third categories (e.g., yellow or red light), the operator classifies 44 the outage as a planned outage, a forced outage or a standby mode.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of determining availability and reliability of facility equipment, the method comprising:
monitoring an operational status of a piece of equipment of a facility;
outputting a visual display illustrating the operational status of the equipment, wherein the operational status is categorized into a plurality of categories, at least one of the plurality of categories requiring an operator to classify an interruption of function of the equipment as one of a planned outage, a forced outage, and a standby mode; and
calculating a reliability percentage of the equipment based on a total amount of time classified as the forced outage; and
calculating an availability percentage of the equipment based on a total amount of time classified as the forced outage and the planned outage.

2. The method of claim 1, wherein the visual display is color-coded to display a distinct color for each of the respective plurality of categories of the operational status of the equipment.

3. The method of claim 1, wherein the plurality of categories of the operational status of the equipment comprises a first category, a second category and a third category.

4. The method of claim 3, wherein the first category comprises a functioning status of the equipment, the second category comprises a currently functioning and recently interrupted functioning status of the equipment, and the third category comprises a non-functioning status of the equipment.

5. The method of claim 4, wherein the visual display is color-coded to display a green light to represent the first category, a yellow light to represent the second category, and a red light to represent the third category.

6. The method of claim 1, further comprising inputting the reliability percentage and the availability percentage into a database.

7. The method of claim 1, further comprising:
calculating an alternate facility reliability and availability percentages from equipment of at least one alternate facility according to the method of claim 1; and
comparing the reliability percentage and the availability percentage to the alternate facility reliability and availability percentages.

8. The method of claim 1, wherein the equipment comprises rotating equipment.

9. The method of claim 1, wherein the equipment comprises at least one of a compressor, a pump, a generator and a turbine.

10. The method of claim 1, wherein the facility comprises a production well facility.

11. The method of claim 1, wherein the operator classifies the interruption of function of the equipment by interacting with the visual display.

12. The method of claim 11, wherein interacting with the visual display comprises contacting a touch screen.

13. The method of claim 11, wherein interacting with the visual display comprises selecting from a pop-up window with a mouse of a computer.

14. The method of claim 1, further comprising:
monitoring the operational status of a plurality of pieces of equipment at the facility;
outputting a visual display illustrating the operational status of each of the plurality of pieces of equipment;
calculating a reliability percentage of each of the pieces of equipment; and
calculating an availability percentage of the equipment.

15. A method of determining availability and reliability of facility equipment, the method comprising:
monitoring an operational status of a piece of equipment of a facility;
outputting a visual display illustrating the operational status of the equipment, wherein the operational status is categorized into a first category, a second category and a third category, the first category comprising a functioning status of the equipment, the second category comprising a currently functioning and recently interrupted functioning status of the equipment, and the third category comprising a non-functioning status of the equipment;
prompting an operator to classify an interruption of function of the equipment as one of a planned outage, a forced outage, and a standby mode, in the event of the equipment being categorized as the second category or the third category; and
classifying the interruption of function of the equipment by interacting with the visual display.

16. The method of claim 15, wherein the visual display is color-coded to display a distinct color for the first category, the second category and the third category, respectively.
